(19) United States
(12) Patent Application Publication
(10) Pub. No.: US 2013/0318284 A1
(43) Pub. Date: Nov. 28, 2013

(54) Data Storage Device and Flash Memory Control Method

(71) Applicant: SILICON MOTION, INC., Jhubei City (TW)

(72) Inventor: Chia-Fang Chang, Hsinchu City (TW)

(73) Assignee: SILICON MOTION, INC., Jhubei City (TW)

(21) Appl. No.: 13/692,709

(22) Filed: Dec. 3, 2012

Related U.S. Application Data
(60) Provisional application No. 61/651,538, filed on May 24, 2012.

(51) Int. Cl. G06F 12/02

(52) U.S. Cl. CPC G06F 12/0246
USPC 711/103

(57) ABSTRACT

A data storage device and a flash memory control method. The disclosed data storage device includes a random access memory, a flash memory and a controller. The flash memory provides a data space for data storage and an in-system-program (ISP) space stored with ISP codes. One of the ISP codes is a permanent-ISP code. The permanent-ISP code contains a look-up table showing how the ISP codes stored in the flash memory map to the random access memory. By the controller, the permanent-ISP code obtained from the flash memory is loaded into the random access memory. Based on the look-up table contained in the permanent-ISP code and loaded in the random access memory with the permanent-ISP code, subsequently requested ISP codes are obtained from the ISP codes of the flash memory and are loaded into the random access memory.

### CROSS REFERENCE TO RELATED APPLICATIONS

This application is a non-provisional of U.S. Provisional Application No. 61/651,538 filed May 24, 2012, the entirety of which is incorporated by reference herein.

### BACKGROUND OF THE INVENTION

1. Field of the Invention

The present invention relates to a data storage device and a flash memory control method.

2. Description of the Related Art

Flash memory is a general non-volatile storage device that is electrically erased and programmed. A NAND Flash, for example, is primarily used in memory cards, USB flash devices, solid-state drives, and so on. One embedded storage solution using a flash memory is eMMC (embedded MultiMediaCard).

Generally, an embedded system is equipped with a small-sized random access memory (RAM). Efficiently using the space of the random access memory is an important issue.

### BRIEF SUMMARY OF THE INVENTION

A data storage device and a flash memory control method are disclosed.

A data storage device in accordance with an exemplary embodiment of the invention comprises: a random access memory (RAM), a flash memory and a controller. The flash memory provides a data space for data storage and an in-system-program (ISP) space stored with ISP codes. One of the ISP codes is a permanent-ISP code, which should be permanently stored by the random access memory when the data storage device is operating. The permanent-ISP code contains a look-up table showing how the ISP codes stored in the flash memory map to the random access memory. By the controller, the permanent-ISP code obtained from the flash memory is loaded into the random access memory. Based on the look-up table contained in the permanent-ISP code and loaded in the random access memory with the permanent-ISP code, subsequently requested ISP codes are obtained from the ISP codes of the flash memory and are loaded into the random access memory.

In another exemplary embodiment of the invention, a method for controlling a flash memory comprises the following steps: storing ISP codes in an ISP space allocated in the flash memory, wherein one of the ISP codes is a permanent-ISP code which contains a look-up table showing how the ISP codes stored in the flash memory map to a random access memory; loading the permanent-ISP code obtained from the flash memory into the random access memory; and, based on the look-up table contained in the permanent-ISP code and loaded in the random access memory with the permanent-ISP code, obtaining subsequently requested ISP codes from the ISP codes stored in the flash memory and loading the subsequently requested ISP codes into the random access memory.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram depicting a data storage device 100 in accordance with an exemplary embodiment of the invention;

FIG. 2 depicts a look-up table LUT in accordance with an exemplary embodiment of the invention;

FIG. 3A depicts the structure of the permanent-ISP code ISP1 in accordance with an exemplary embodiment of the invention;

FIG. 3B depicts the structure of ISPi in accordance with an exemplary embodiment of the invention; and

FIG. 4 is a flowchart depicting an ISP loading scheme, which may be coded as a program named ISP loader in the ROM code to be executed by the controller 106.

### DETAILED DESCRIPTION OF THE INVENTION

The following description shows several exemplary embodiments for carrying out the invention. This description is made for the purpose of illustrating the general principles of the invention and should not be taken in a limiting sense. The scope of the invention is best determined by reference to the appended claims.

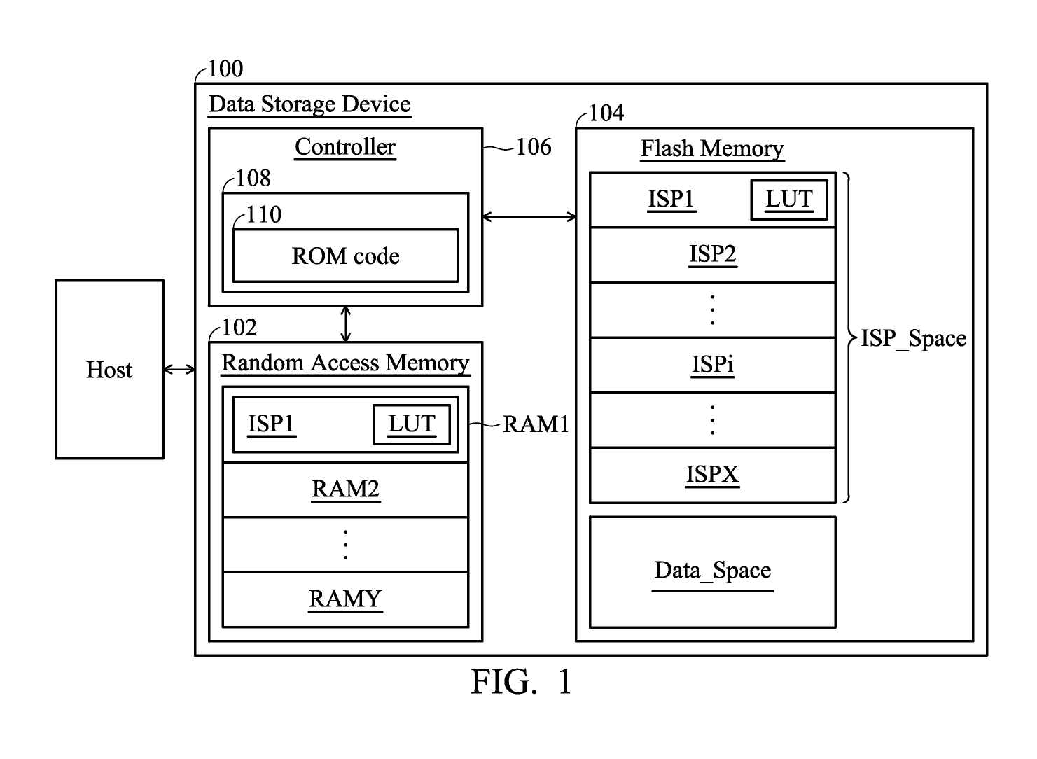

FIG. 1 is a block diagram depicting a data storage device 100 in accordance with an exemplary embodiment of the invention. The data storage device 100 comprises a random access memory (RAM) 102, a flash memory 104 and a controller 106. The flash memory 104 provides a data space Data_Space for data storage and an in-system-program (ISP) space ISP_Space stored with ISP codes ISP1, ISP2 . . . ISPi . . . ISPX.

The ISP code ISP1 is a permanent-ISP code, which should be permanently contained in the random access memory 102 when the data storage device 100 is operating. Note that the permanent-ISP code ISP 1 contains a look-up table LUT showing how the ISP codes (including ISP1, ISP2 . . . ISPi . . . ISPX) stored in the flash memory 104 map to the random access memory 102. For example, the look-up table LUT may show how to use the allocated memory spaces RAM1, RAM2 . . . RAMY to store the ISP codes ISP1, ISP2˜ISPX obtained from the flash memory 104.

By the controller 106, the permanent-ISP code ISP1 may take the lead to be loaded into the random access memory 102. In the exemplary embodiment of FIG. 1, between the RAM spaces RAM1, RAM2 . . . RAMY allocated for the ISP codes, the beginning RAM space RAM1 is loaded with the permanent-ISP code IPS1. Based on the look-up table LUT contained in the permanent-ISP code ISP1 and loaded in the random access memory 102 with the permanent-ISP code ISP1, the controller 106 obtains the subsequently requested ISP codes from the flash memory 104 and loads the obtained ISP codes into the random access memory 102. Note that the look-up table LUT is permanently contained in the random access memory 102 when the data storage device 100 is operating. In comparison with a look-up table which is not permanently stored in the random access memory when the data storage device is operating, the disclosed permanent look-up table LUT effectively improves the work efficiency of the data storage device 100 because reloading of a look-up table every time a new ISP code is requested is not required.

Further, the vendor may establish different look-up tables for different user requirements. The space utilization of the random access memory 102 is more flexible, favorable for an embedded device.

Further, as shown, the controller 106 may include a read only memory (ROM) 108 which is stored with a ROM code 110. The ROM code 110 may introduce a Startup scheme which includes a Loader procedure. By executing the Loader procedure, the controller 106 loads the random access memory 102 with the permanent-ISP code ISP1 and any of the remaining ISP codes ISP2˜ISPX according to the aforementioned technique.

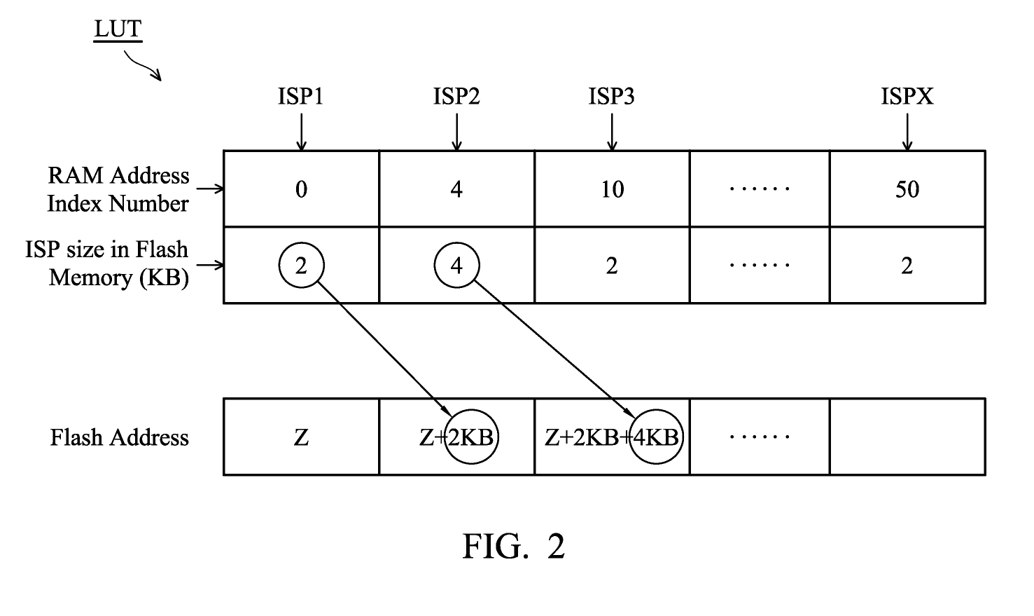

In this paragraph, the look-up table LUT is discussed in detail. To show how the ISP codes ISP1˜ISPX stored in the flash memory 104 map to the random access memory 102, the look-up table LUT is established to provide RAM address information and flash address information for the different ISP codes ISP1˜ISPX. For a small-sized look-up table LUT, the RAM address and flash address information may be simplified from the complete RAM addresses and flash addresses. FIG. 2 shows a look-up table LUT in accordance with an exemplary embodiment of the invention. The RAM address information about the different ISP codes ISP1˜ISPX is represented by RAM address index numbers. For example, a RAM address index number may be obtained by right shifting a RAM address RAM_Addr by 9 bits (RAM_Addr>>9). Storing a RAM address index number requires fewer bits than storing a complete RAM address. The RAM addresses for loading of the different ISP codes may correspond to different RAM spaces of RAM1˜RAMY. Further, the look-up table LUT shown in FIG. 2 provides size information about each of the ISP codes ISP1˜ISPN for evaluation of the flash address information. The evaluation may be executed by the controller 106 shown in FIG. 1. In cases where the flash address of ISP 1 is Z, the flash address of ISP2 is Z+2 KB where 2 KB is the size of ISP1, and the flash address of ISP3 is Z+(2 KB+4 KB) where (2 KB+4 KB) is the total size of ISP2 and ISP3. Storing the size information for the ISP codes requires less space than storing the flash addresses of the ISP codes. It is more feasible to package the small-sized look-up table LUT within the permanent-ISP code ISP1.

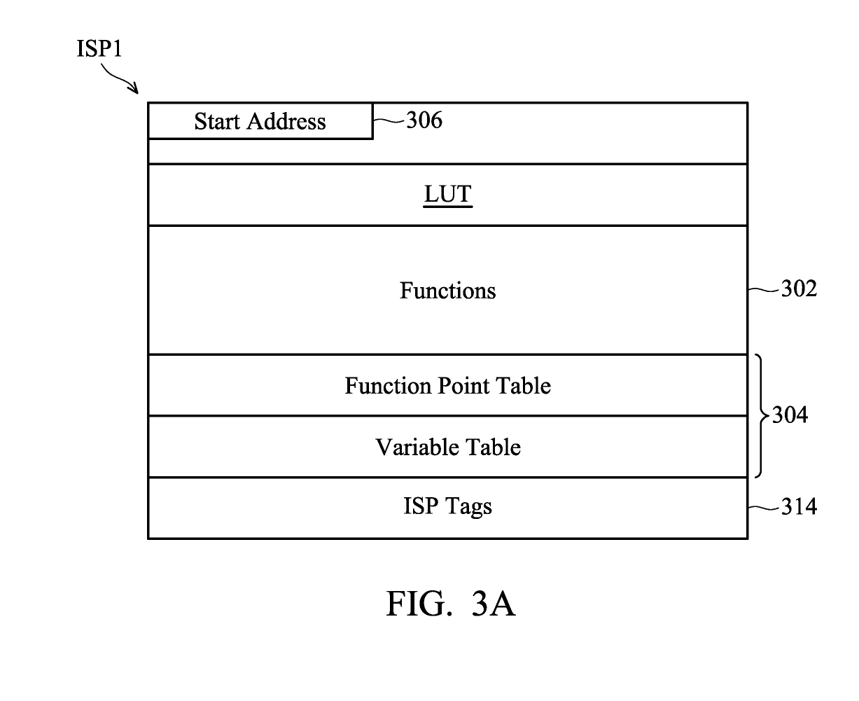

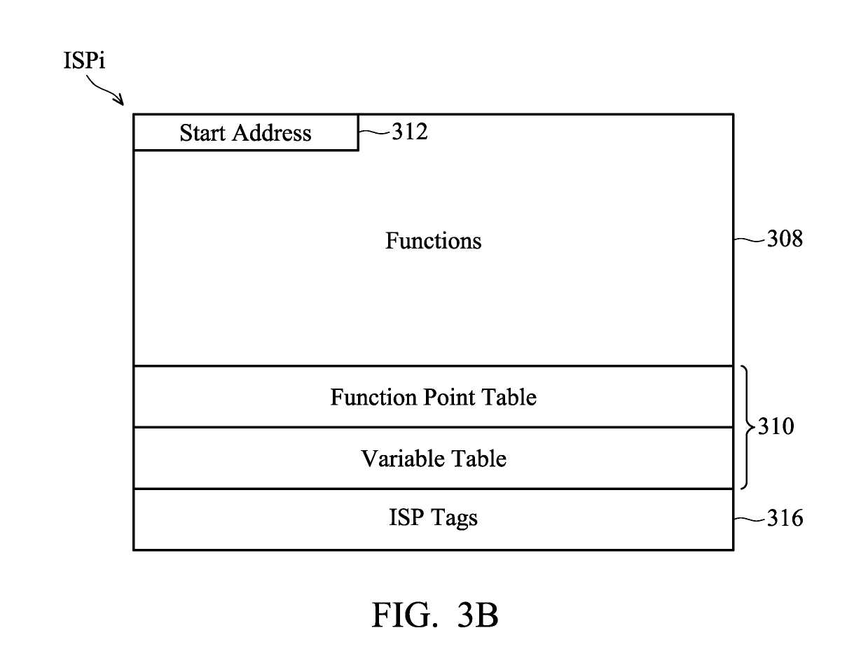

In an exemplary embodiment, the size of one ISP code is a multiple of 512 bytes. FIG. 3A depicts the structure of the permanent-ISP code ISP1 in accordance with an exemplary embodiment of the invention. As for the remaining ISP codes ISP2˜ISPX, FIG. 3B depicts the structure of ISPi in accordance with an exemplary embodiment of the invention.

In permanent-ISP code ISP1, functions 302 are coded prior to tables of interface variables 304 and are coded after the look-up table LUT. Further, ISP1 provides a start address 306 directing to the functions 302 by indicating the RAM spaces allocated to the functions 302. The start address 306, as shown, may be coded at the beginning of ISP1.

As for the remaining ISP codes ISP2˜ISPX, the structure of ISPi is discussed as a representative example. Referring to ISPi of FIG. 3B, functions 308 are coded prior to tables of interface variables 310. Further, ISPi provides a start address 312 directing to the functions 308 by indicating the RAM spaces allocated to the functions 308. The start address 312, as shown, may be coded at the beginning of ISPi.

The tables of interface variables 304/310 may include a function point table and a variable table. In each ISP code, the start address 306/312 and the tables of interface variables 304/310 are operative to establish an interface between all ISP codes ISP1˜ISPX. Further, ISP tags 314/316, including the date, version and serial number of an ISP code, may be coded after the tables of interface variables 304/310. In an exemplary embodiment wherein the size of each ISP code is a multiple of 512 bytes, the less frequently used data (including those announced in the tables of interface variables 304/310 and the ISP tags 314/316) are coded in the latter part of an entire ISP code (as shown in FIGS. 3A and 3B). Thus, the space utilization and work efficiency of the random access memory 102 are considerably improved.

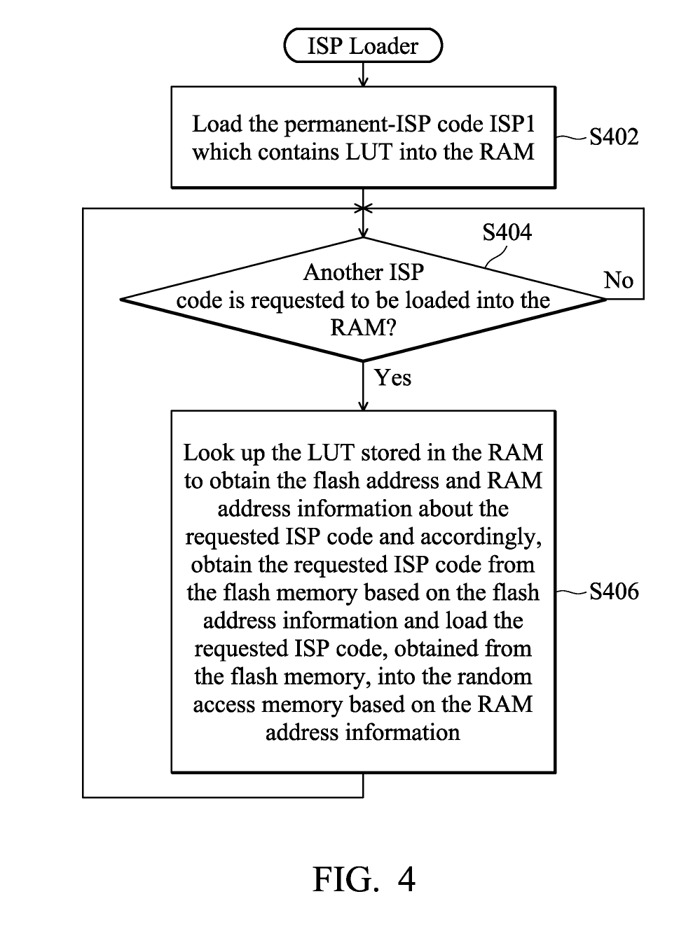

FIG. 4 is a flowchart depicting an ISP loading scheme, which may be coded as a program named ISP loader in the ROM code to be executed by the controller 106. In step S402, the permanent-ISP code ISP1 obtained from the flash memory 104 is loaded into the random access memory 102 (e.g., loaded into the RAM space RAM1). In step S404, it is monitored whether another ISP code is requested and to be loaded into the random access memory 102. When loading of another ISP code is requested, step S406 is performed. In step S406, the flash address information and the RAM address information about the requested ISP code is obtained from the look-up table LUT stored in the random access memory 102 (e.g., loaded in the RAM space RAM1), and then the requested ISP code is obtained from the flash memory 104 based on the obtained flash address information and is loaded into the random access memory 102 according to the obtained RAM address information.

In another exemplary embodiment of the invention, a method for controlling a flash memory is shown and is discussed with reference to the flash memory 104 of FIG. 1. The disclosed method comprises the following steps: storing ISP codes ISP1˜ISPX in an ISP space ISP_Space allocated in the flash memory 104, wherein one of the ISP codes is a permanent-ISP code (ISP1) which contains a look-up table LUT showing how the ISP codes ISP1˜ISPX stored in the flash memory 104 map to a random access memory (e.g. 102 of FIG. 1); loading the permanent-ISP code ISP1 obtained from the flash memory 102 into the random access memory 102; and, based on the look-up table LUT contained in the permanent-ISP code ISP1 and loaded in the random access memory 102 with the permanent-ISP code ISP1, obtaining subsequently requested ISP codes from the ISP codes stored in the flash memory 104 and loading the subsequently requested ISP codes into the random access memory 102.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a random access memory;
a flash memory, providing a data space for data storage and an in-system-program space stored with in-system-program codes, wherein a permanent-in-system-program code between the in-system-program codes contains a look-up table; and
a controller, loading the permanent-in-system-program code obtained from the flash memory into the random access memory and, based on the look-up table, obtaining subsequently requested in-system-program codes and loading the subsequently requested in-system-program codes into the random access memory.

2. The data storage device as claimed in claim 1, wherein, for each of the in-system-program codes, the look-up table provides a RAM address index number for evaluation of a RAM address, the RAM address index number requires fewer bits than storing all bits of the RAM address.

3. The data storage device as claimed in claim 1, wherein:
the look-up table provides size information about each of the in-system-program codes; and
the controller evaluates a flash address of a requested in-system-program code based on the size information.

4. The data storage device as claimed in claim 1, wherein, in the in-system-program codes, functions are coded prior to tables of interface variables.

5. The data storage device as claimed in claim 4, wherein, in the permanent-in-system-program code, the functions are coded after the look-up table.

6. The data storage device as claimed in claim 5, wherein each of the in-system-program codes provides a start address directing to the functions corresponding thereto.

7. The data storage device as claimed in claim 1, wherein, the look-up table shows how the in-system-program codes stored in the flash memory map to the random access memory.

8. The data storage device as claimed in claim 1, wherein, the look-up table is contained in the permanent-in-system-program code to be loaded into the random access memory with the permanent-in-system-program code.

9. A method for controlling a flash memory, comprising:
storing in-system-program codes in an in-system-program space allocated in the flash memory, wherein one of the in-system-program codes is a permanent-in-system-program code which contains a look-up table;
loading a random access memory with the permanent-in-system-program code obtained from the flash memory; and
based on the look-up table, obtaining subsequently requested in-system-program codes and loading the subsequently requested in-system-program codes into the random access memory.

10. The method as claimed in claim 9, wherein, for each of the in-system-program codes, the look-up table provides a RAM address index number for evaluation of a RAM address, the RAM address index number requires fewer bits than storing all bits of the RAM address.

11. The method as claimed in claim 9, wherein the look-up table provides size information about each of the in-system-program codes.

12. The method as claimed in claim 11, further evaluating a flash address of a requested in-system-program code based on the size information.

13. The method as claimed in claim 9, wherein, in the in-system-program codes, functions are coded prior to tables of interface variables.

14. The method as claimed in claim 13, wherein, in the permanent-in-system-program code, the functions are coded after the look-up table.

15. The method as claimed in claim 14, wherein, each of the in-system-program codes provides a start address directing to the functions corresponding thereto.

16. The method as claimed in claim 9, wherein the look-up table shows how the in-system-program codes stored in the flash memory map to the random access memory.

17. The method as claimed in claim 9, wherein, wherein, the look-up table is contained in the permanent-in-system-program code to be loaded into the random access memory with the permanent-in-system-program code.
